(19) United States
(12) Patent Application Publication
(10) Pub. No.: US 2005/0065809 A1
(43) Pub. Date: Mar. 24, 2005

(54) System and methods for maximizing donations and identifying planned giving targets

(75) Inventor: Lawrence Henze, Littleton, CO (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Blackbaud, Inc., Charleston, SC (US)

(21) Appl. No.: 10/901,891

(22) Filed: Jul. 29, 2004

Related U.S. Application Data
(60) Provisional application No. 60/491,204, filed on Jul. 29, 2003.
(60) Provisional application No. 60/491,017, filed on Jul. 29, 2003.

(51) Int. Cl. G06F 17/60

(52) U.S. Cl. 705/1

(57) ABSTRACT

To enable a non-profit to make informed decision about how to spend its limited resources efficiently to maximize its donations, systems and methods to determine prospect propensity and prospect capacity to identify what types of donations, such as annual gifts, major one-time gifts, or planned gifts, the non-profit should solicit from its pool of prospective donors and the likely amount of each such gift. Systems and methods that enable the non-profit further to identify what types of planned gift, such as bequests, charitable remainder trusts, charitable gift annuities, pooled income funds, and life insurance, it should solicit from each of its prospective donors. The systems and methods use models developed using statistical analysis to generate relative scores for all prospective donors in the pool. Such scores and additional wealth information are provided to the non-profit in electronic format for further manipulation and use.

### CROSS REFERENCE TO RELATED APPLICATION

This application claims the benefit under 35 U.S.C. §119(e) of U.S. Provisional Patent Application Ser. Nos. 60/491,017 for “Method and System for Maximizing Donations by Analyzing Prospect Propensity and Capacity” and 60/491,204 for “Method and System for Identifying Planned Giving Targets,” both of which were filed Jul. 29, 2003, and both of which are incorporated herein by reference in their entirety.

### FIELD OF THE INVENTION

The present invention relates generally to computer systems and models used for nonprofit fundraising and, more particularly, to methods and systems for maximizing donations by analyzing propensity and capacity of a donor prospect to donate and by identifying planned giving targets from a pool of potential donors.

### BACKGROUND OF THE INVENTION

Running a successful non-profit organization is similar to running a business. For example, a successful business must be clear about the products it offers, must understand the audience it is trying to reach, and must use market strategies to attract its target audience. In addition, for a business to succeed, it must grow its market, minimize its expenses, and maximize its revenues.

Similarly, a non-profit organization must implement strategies to define its product and services, to identify and grow its base of existing and prospective donors, and to maximize donations from this base of existing and prospective donors in a cost-effective manner. To meet this challenge, a non-profit organization must answer two primary questions: (i) which donors/prospects should be solicited for a donation to the organization; and (ii) when such donors/prospects are solicited, how much should be solicited. To extend the for-profit corporate analogy, which consumers are likely to buy our widgets and how much will they pay for them?

Currently, non-profit organizations make these decisions based on antecdotal data, industry or conventional wisdom, best guesses, and by repeated solicitation of the same donors who have historically been large or consistent donors to the organization.

There is a third question that non-profit organizations often ask or should ask: (iii) what type of donation should be solicited? To extend the for-profit corporate analogy, which widgets should we offer? For example, there are many different types of possible donation vehicles, such as annual gifts, major one-time gifts, smaller periodic gifts, and planned gifts. Further, there are a wide and sometimes confusing variety of planned giving options, including bequests, charitable remainder trusts, charitable gift annuities, pooled income funds, and life insurance. Each planned giving vehicle appeals differently to different people. But sending out vast amounts of literature on all types of planned giving vehicles to a large number of prospects is likely to be both costly and inefficient. Nonprofits, like successful businesses, need to understand the different planned gift vehicles, the audience each vehicle appeals to and use market strategies to attract the right prospects to the right vehicle.

Unfortunately, it is common for non-profit organizations to focus on only one or two primary variables, such as age, to segment its database into those individuals most likely to give a planned gift. Such variables may or may not correctly correlate what type of solicitation such segment should receive. For example, if only age were used, a non-profit organization would likely mail out, to all of its prospective donors over the age of 65, a 3-page glossy brochure explaining the benefits of making a planned gift and outlining all of their planned giving options. Since many individuals have not even heard of Charitable Remainder Unitrusts, Charitable Remainder Annuity Trusts, Charitable Gift Annuities, etc. (let alone understand how they work and which option is best for their individual circumstances), the resulting response rates are, not surprisingly, very low.

Thus, there is a need for a system and methods that enable a non-profit organization effectively and accurately to identify both “prospect propensity” and “prospect capacity” from its pool or base of prospective donors. In other words, a non-profit organization needs an effective way to determine the likelihood that each prospective donor in its database will donate to the organization. The non-profit organization also needs an effective way to determine the financial ability of each such prospective donor to make a contribution to the organization. With such knowledge, the non-profit organization is able to make better-informed decisions about which prospective donors should be solicited for donations and what level or size of donations should be solicited.

There is also a need for a system and methods for a non-profit organization effectively to determine what types of donations, such as annual gifts, major one-time gifts, smaller periodic gifts, or planned gifts, it should expect and solicit from its pool of prospective donors.

There is also a need for a system and methods that enable the non-profit organization to identify what type of planned gift each prospective donor is most likely to be interested in using to donate to or support the non-profit organization. Such knowledge provides the non-profit organization with an even more informed decision about how to spend its limited resources to maximize its donations from its pool of prospective donors.

Finally, for all of the above reasons, there remains a general need for systems and methods that enable a non-profit organization to make better informed decisions about how to solicit its pool of prospective donors in the most effective manner to maximize donations while minimizing its solicitation expenses.

### SUMMARY OF THE INVENTION

The present invention relates generally to computer systems and models used for nonprofit fundraising and, more particularly, to methods and systems for maximizing donations by analyzing propensity and capacity of a prospective donor to donate to a particular non-profit organization and by targeting of planned giving vehicle of potential interest to each prospective donor from a pool of prospective donors of the non-profit organization.

A first aspect of the present invention generally relates to methods and a system for providing a custom, predictive modeling service that identifies the propensity of giving for each prospect in a non-profit's database, which identifies the pool of prospective donors for the non-profit organization. An asset screening system is used to identify indicators of wealth that can be used to estimate a given prospect's capacity to give each type of donation.

More specifically, the system of the present invention receives data from a non-profit organization containing information on various prospective donors, such as name, address, and giving history. This information is matched and combined with individual and household demographic and financial data, aggregated credit data, and U.S. census data to create composite data associated with each prospective donor from the pool.

The composite data is then analyzed using statistical analysis. Preferably, each prospect receives a propensity score that is normalized with a range of possible scores, such as between 0 and 1000. Also, preferably, each prospect receives a separate propensity score for each type of donation. The higher the score, the more the prospect resembles the characteristics of a particular type of donor, e.g., an annual gift donor, a major gift donor, or a planned gift donor and, thus, the more likely that prospect is to give a donation of that type. The propensity scores are then used by the non-profit organization development staff to segment their database into their best prospective donors.

Stated in another way, in the first aspect of the invention, a method of identifying best prospective donors from a pool of prospective donors of a non-profit organization, comprises the steps of obtaining client data regarding the pool of prospective donors from the non-profit organization; obtaining public data from a database, the public data including data specific to prospective donors in the pool and general demographic data; merging the client data with relevant portions of the public data to create composite data for each prospective donor in the pool; applying statistical analysis to a plurality of key variables from the composite data; based on the applied statistical analysis, generating a propensity score for each prospective donor in the pool, each respective propensity score indicative of the relative likelihood that the corresponding prospective donor will donate to the non-profit organization as compared to other prospective donors in the pool; based on the statistical analysis, generating a capacity score for each prospective donor in the pool, each respective capacity score indicative of the financial ability of the corresponding prospective donor to donate to the non-profit organization; and providing the propensity and capacity scores for each prospective donor in the pool to the non-profit organization whereby the non profit organization is able to target more effectively its requests for donations from the pool of prospective donors.

In a feature, the client data comprises one or more of name, address, age, income, marital status, family status, involvement level with the non-profit organization, and donation history to the non-profit organization of each prospective donor in the pool. Preferably, the donation history of each prospective donor in the pool is indicative of the consistency and level of giving by the respective donor to the non-profit organization.

In another feature, the public data specific to each prospective donor includes credit report data and asset data.

In yet a further feature, the general demographic data include one or more of census data, median income and median home value based on zip code, and aggregate credit data.

In a feature, the step of applying statistical analysis comprises developing a custom statistical model based on probit regression analysis using the key variables relevant to the non-profit organization. Preferably, the method further comprises testing the custom statistical model on composite data of prospective donors not in the pool using receiver/operator characteristic, r-squared, and d-prime to determine the accuracy and reliability of the custom statistical model.

In another feature, the step of applying statistical analysis comprises developing a prescriptive statistical model based on probit regression analysis using both industry data and the key variables relevant to the non-profit organization. Preferably, the method further comprises testing the prescriptive statistical model on composite data of prospective donors not in the pool using receiver/operator characteristic, r-squared, and d-prime to determine the accuracy and reliability of the prescriptive statistical model.

In further features, the propensity score includes an annual gift likelihood score, a major gift likelihood score, and/or a planned gift likelihood score.

In yet a further feature, the capacity score is indicative of a dollar value range in which the prospective donor is likely to donate to the non-profit organization.

In a feature, the method further comprises the step of ranking the prospective donors based on their respective propensity score.

In another feature, the method further comprises the step of ranking the prospective donors based on their respective capacity score.

In yet a further feature, the method further comprises providing specific financial information about each prospective donor in the pool to the non-profit organization, the specific financial information including one or more of property ownership data, salary data, membership data, political contribution data, stock ownership data, and business title data.

In a feature, the method further comprises formatting the client data into a standardized format.

In another feature, the method further comprises identifying only a top plurality of prospective donors from the pool based on their respective propensity and capacity scores, creating a report with a list of the top plurality, associating specific financial information about each prospective donor of the top plurality in the report, and providing the report to the non-profit organization. Preferably, the report is provided to the non-profit organization as part of a software viewer application having a graphic user interface by which the non-profit organization is able to view the report and/or the report is accessible by the non-profit organization over the Internet through a password-protected web interface.

In another first aspect of the present invention, a method of identifying best prospective donors from a pool of prospective donors of a non-profit organization, comprises the steps of obtaining client data regarding the pool of prospective donors from the non-profit organization, wherein the client data comprises one or more of name, address, age, income, marital status, family status, involvement level with the non-profit organization, and donation history to the non-profit organization of each prospective donor in the pool; obtaining public data from a database, the public data including data specific to prospective donors in the pool and general demographic data; merging the client data with relevant portions of the public data to create composite data for each prospective donor in the pool; generating statistical models having a plurality of key variables based on probit regression analysis of the composite data; generating a plurality of propensity scores for each prospective donor in the pool by applying the statistical models to the plurality of key variables in the composite data, each of the plurality of propensity scores indicative of the relative likelihood that the corresponding prospective donor will donate an annual gift, a major gift, and a planned gift to the non-profit organization as compared to other prospective donors in the pool; and generating a capacity score for each prospective donor in the pool by applying the statistical models to the plurality of key variables in the composite data, each respective capacity score indicative of the financial ability of the corresponding prospective donor to donate to the non-profit organization; and providing the propensity and capacity scores for each prospective donor in the pool to the non-profit organization whereby the non profit organization is able to target more effectively its requests for donations from the pool of prospective donors.

In a feature, the donation history of each prospective donor in the pool is indicative of the consistency and level of giving by the respective donor to the non-profit organization.

In another feature, the public data specific to each prospective donor includes credit report data and asset data.

In a further feature, the general demographic data include one or more of census data, median income and median home value based on zip code, and aggregate credit data.

In a feature, at least one of the statistical models is customized using the key variables relevant to the non-profit organization. Preferably, this method further comprises testing the customized statistical model on composite data of prospective donors not in the pool using receiver/operator characteristic, r-squared, and d-prime to determine the accuracy and reliability of the customized statistical model.

In another feature, at least one of the statistical models is prescriptive using both industry data and the key variables relevant to the non-profit organization. Preferably, the method further comprises testing the prescriptive statistical model on composite data of prospective donors not in the pool using receiver/operator characteristic, r-squared, and d-prime to determine the accuracy and reliability of the prescriptive statistical model.

In another feature, the capacity score is indicative of a dollar value range in which the prospective donor is likely to donate to the non-profit organization.

In a feature, the method further comprises the step of ranking the prospective donors based on one of their respective propensity scores.

In another feature, the method further comprises the step of ranking the prospective donors based on all of their respective propensity scores.

In yet a further feature, the method further comprises the step of ranking the prospective donors based on their respective capacity score.

In a feature, the method further comprises providing specific financial information about each prospective donor in the pool to the non-profit organization, the specific financial information including one or more of property ownership data, salary data, membership data, political contribution data, stock ownership data, and business title data.

In yet a further feature, the method further comprises formatting the client data into a standardized format before merging the client data with relevant portions of the public data.

In another feature, the method further comprises identifying only a top plurality of prospective donors from the pool based on their respective propensity and capacity scores, creating a report with a list of the top plurality, associating specific financial information about each prospective donor of the top plurality in the report, and providing the report to the non-profit organization. Preferably, the report is provided to the non-profit organization as part of a software viewer application having a graphic user interface by which the non-profit organization is able to view the report and/or the report is accessible by the non-profit organization over the Internet through a password-protected web interface.

A second aspect of the present invention generally relates to a system and methods for identifying the best planned giving vehicle to solicit from each prospective donor in the non-profit's database. Using statistical models, based on over 100,000 individuals from over 40 non-profit organizations, the present system predicts the likelihood that a prospective donor will give one of five (5) different types of planned gifts, including bequests, charitable remainder trusts (CRT), charitable gift annuity (CGA), pooled income fund (PIF), and life insurance policies. These models provide a non-profit organization with a more accurate way to segment their database according to those prospective donors most likely to make a specific type of planned gift. Such segmentation enables non-profits to send different marketing messages or solicitation packages to each segment, reducing expensive mailings and increasing the efficiency of their marketing efforts.

For example, prospective donors who have high CRT likelihood scores, meaning they have the characteristics of someone likely to establish a CRT, are targeted to receive a brochure outlining the benefits of establishing a CRT. Prospective donors who have high CGA/PIF likelihood scores are targeted to receive a brochure outlining the benefits of a contributing to the organization's Charitable Gift Annuity or Pooled Income Fund. The response rates for each mailing increases since individuals are no longer confused by the vast array of options and since they are receiving planned gift information that is most relevant to them. Also, the expense of a fundraiser mailing has dramatically decreased. The brochures are smaller and the number of brochures mailed has decreased, since the organization can now mail to only those individuals most likely to give that specific type of planned gift. By better understanding the audience they are trying to reach and using market segmentation, non-profit organizations are able to improve the efficiency and effectiveness of their planned giving programs.

Stated another way, in the second aspect of the present invention, a method of identifying best prospective donors of a particular planned gift from a pool of prospective donors of a specific non-profit organization, comprises the steps of developing a statistical model indicative of the likelihood of an individual to make the particular planned gift in contrast with other types of planned gifts, the statistical model based on historical data of a plurality of individuals who have historically made donations of the particular planned gift to non-profit organizations, the statistical model having a plurality of key variables; obtaining client data regarding the pool of prospective donors from the specific non-profit organization; generating a propensity score for each prospective donor in the pool by applying the statistical model to the plurality of key variables in the client data, each respective propensity score indicative of the relative likelihood that the corresponding prospective donor will donate the planned gift to the specific non-profit organization as compared to other prospective donors in the pool; and providing the propensity score for each prospective donor in the pool to the non-profit organization whereby the non profit organization is able to target more effectively its requests for donations using the planned gift from the pool of prospective donors.

In a feature, the planned gift is a bequest, a charitable remainder trust, a charitable gift annuity, a pooled income fund, and/or life insurance.

In a further feature, the client data comprises one or more of name, address, age, income, marital status, family status, involvement level with the non-profit organization, and donation history to the non-profit organization of each prospective donor in the pool. Preferably, the donation history of each prospective donor in the pool is indicative of the consistency and level of giving by the respective donor to the non-profit organization.

In yet a further feature, the method further comprises the step of ranking the prospective donors based on their respective propensity score.

In another feature, the method further comprises extracting the plurality of key variables from the client data before generating the propensity scores.

In yet a further feature, the method further comprises identifying only a top plurality of prospective donors from the pool based on their respective propensity scores, creating a report with a list of the top plurality, and providing the report to the specific non-profit organization. Preferably, the report is provided to the specific non-profit organization as part of a software viewer application having a graphic user interface by which the specific non-profit organization is able to view the report and/or the report is accessible by the specific non-profit organization over the Internet through a password-protected web interface.

In another second aspect of the present invention, a method of identifying best prospective donors of a plurality of planned gifts from a pool of prospective donors of a specific non-profit organization, comprises the steps of developing a plurality of statistical models, each statistical model associated with a respective one of the plurality of planned gifts, each statistical model based on historical data of individuals who have historically made donations of the respective one of the plurality of planned gifts to a non-profit organization, each statistical model having a respective plurality of key variables; obtaining client data regarding the pool of prospective donors from the specific non-profit organization; for each respective statistical model, generating a propensity score for each prospective donor in the pool by applying the statistical model to the respective plurality of key variables in the client data, each respective propensity score indicative of the relative likelihood that the corresponding prospective donor will donate the associated planned gift to the specific non-profit organization as compared to other prospective donors in the pool; and providing the propensity scores for each prospective donor in the pool to the non-profit organization whereby the non profit organization is able to target more effectively its requests for donations using the plurality of planned gift from the pool of prospective donors.

In a feature, the planned gift is a bequest, a charitable remainder trust, a charitable gift annuity, a pooled income fund, and/or life insurance.

In a further feature, the client data comprises one or more of name, address, age, income, marital status, family status, involvement level with the non-profit organization, and donation history to the non-profit organization of each prospective donor in the pool. Preferably, the donation history of each prospective donor in the pool is indicative of the consistency and level of giving by the respective donor to the non-profit organization.

In yet a further feature, the method further comprises the step of ranking the prospective donors based on their respective propensity score.

In another feature, the method further comprises extracting the plurality of key variables from the client data before generating the propensity scores.

In yet a further feature, the method further comprises identifying only a top plurality of prospective donors from the pool based on their respective propensity scores, creating a report with a list of the top plurality, and providing the report to the specific non-profit organization. Preferably, the report is provided to the specific non-profit organization as part of a software viewer application having a graphic user interface by which the specific non-profit organization is able to view the report and/or the report is accessible by the specific non-profit organization over the Internet through a password-protected web interface.

The present invention also encompasses computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a system overview diagram of a preferred embodiment of the present invention;

FIG. 2 is an exemplary screen shot of a list of prospective donors in the first aspect of the present invention;

FIG. 3 is an exemplary screen shot of a specific prospective donor in the first aspect of the present invention;

FIG. 4 is an exemplary screen shot of a specific wealth report associated with the prospective donor of FIG. 3;

FIG. 5 is an exemplary screen shot of input data associated with a list of prospective donors in the first aspect of the present invention;

FIG. 6 is an exemplary screen shot of further input data associated with a list of prospective donors in the first aspect of the present invention;

FIG. 7 is a table of variable associated with a first model of the second aspect of the present invention;

FIG. 8 is a pie graph chart associated with the table in FIG. 7;

FIG. 9 is a dual axis graph associated with the table in FIG. 7;

FIG. 10 is a table of variables associated with a second model of the second aspect of the present invention;

FIG. 11 is a pie graph chart associated with the table in FIG. 10;

FIG. 12 is a table of variables associated with a third model of the second aspect of the present invention;

FIG. 13 is a pie graph chart associated with the table in FIG. 12;

FIG. 14 is a table of variables associated with a fourth model of the second aspect of the present invention;

FIG. 15 is a pie graph chart associated with the table in FIG. 14;

FIG. 16 is a dual axis graph associated with a preferred method of developing statistical models associated the present invention;

FIG. 17 is a dual axis graph associated with the graph of FIG. 16;

FIG. 18 is another dual axis graph associated with the graph of FIG. 16;

FIG. 19 is a table with variables and their relative weights associated with an exemplary model of the present invention;

FIG. 20 is a table illustrating empirical Bayes estimates for a City-State variable of an exemplary statistical model of the present invention;

FIG. 21 is a table illustrating empirical Bayes estimates for a Constituent Code variable of an exemplary statistical model of the present invention;

FIG. 22 is a table with variables and their relative weights associated with another exemplary model of the present invention.

### DETAILED DESCRIPTION OF THE INVENTION

A. System Overview

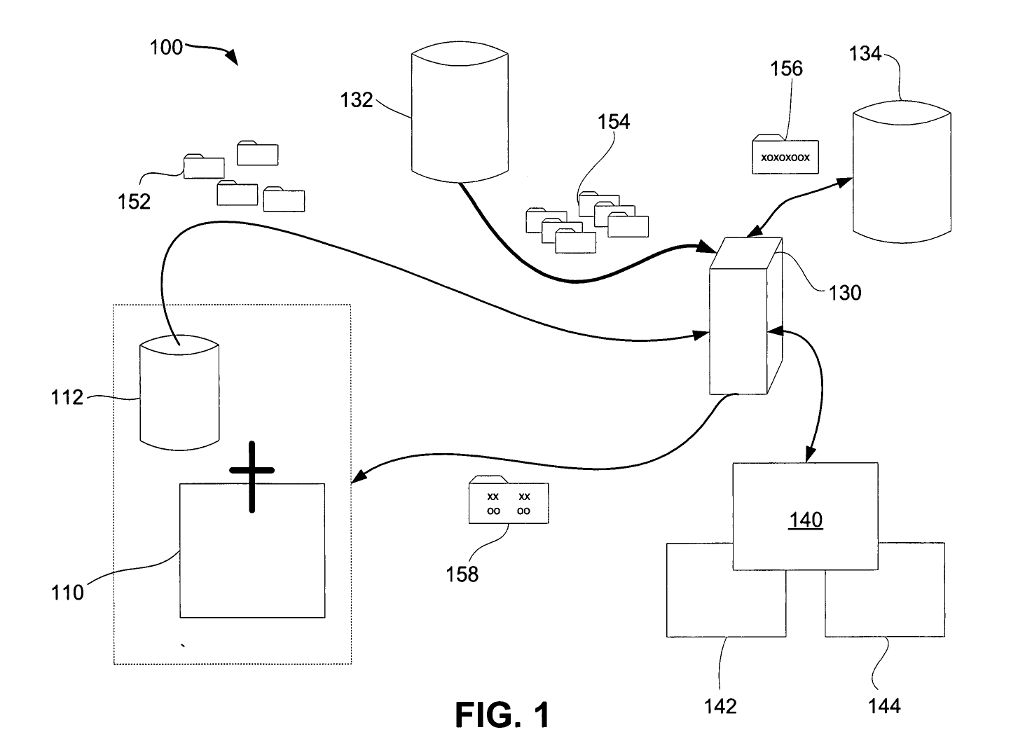

Turning now to FIG. 1, a system 100 of the present invention is illustrated. The system 100 includes a nonprofit organization or charity 110 and a prospective donor analyzer system 130. The analyzer system 130 is preferably operated by a third party system (separate from the non-profit organization), which is accessed or used by the non-profit 110. Access to the analyzer system 130 by the non-profit is through conventional electronic/computer communications or over an internal or external network, such as the Internet. Alternatively, the analyzer system 130 is a software application operated and accessible by the non-profit 110 itself on one of its own computer servers. A non-profit organization database 112 is associated with the non-profit 110. The non-profit organization database 112 stores client data that includes donor information associated with a pool of prospective donors to the non-profit 110. Such donors may have donated to the non-profit 110 in the past, may be on the non-profit's mailing list, are affiliated with the non-profit 110, or have some other relationship or interest in the non-profit 110. Such client data includes information such as name, address, age, income, marital status, family status, involvement level with the non-profit organization, and donation history to the non-profit organization of each prospective donor in the pool. Donation history is indicative of the consistency and level of giving by the respective donor to the charity or non-profit organization.

The analyzer system 130 has access to one or more public databases 132, to its own data storage 134, and to a modeler 140. The modeler 140 includes both custom modeler 142 and an industry standard modeler 144.

In normal operation, the non-profit 110 accesses or makes use of the analyzer system 130 to determine which of the prospective donors from its database 112 it should solicit as part of a fundraising campaign. Often, it will be cost-prohibitive to solicit all of the prospective donors in its database 112 for every single fundraising campaign. For this reason, it makes more sense for the non-profit 110 to send out targeted solicitation requests to selected prospective donors from its database 112. Thus, the non-profit 110 desires to know which segment of the prospective donors in its database 112 are more likely to give an annual gift, a major gift, or a planned gift. Also, the charity 110 wants to know what size of a gift each prospective donor can give. Further, the non-profit 110 would like to know, of those prospective donors likely to give a planned gift, what type of planned gift such prospective donor would be more likely to give: a bequest, a charitable remainder trust (CRT), charitable gift annuity (CGA), a pooled income fund, and/or life insurance.

The non-profit 110 makes use of the analyzer system 130 to help it make informed decisions about which prospective donors from its database 112 should receive a solicitation, how much or what level donation should be solicited, and what information (e.g., what type of recommended gift) should be included with the solicitation.

In a first preferred embodiment of the present invention, a method of identifying best prospective donors from a pool of prospective donors of a non-profit organization is disclosed. Initially, the non-profit organization 110 provides its raw donor data or client data 152 to the analyzer system 130 for processing and analysis. Such data 152 is converted in conventional manner to a standardized format, if necessary. Conversion or reformatting of the client data 152 is done by the analyzer system 130 or by an intermediary (not shown) prior to the client data 152 being provided to the analyzer system 130. The analyzer system 130 also obtains public data 154 from one or more public databases 132. Such public data 154 includes data specific to the prospective donors in the pool and it also includes general demographic data. Preferably the public data specific to each prospective donor includes credit report data and asset data, if available. The general demographic data preferably includes census data, median income and median home value based on zip code, and aggregate credit data. Such demographic data is not necessarily specific to any particular prospective donor but is generally relevant to prospective donors based on where each such donor lives. The public data 154 may be available from “for fee” and/or “free” public databases 132. The relevant portions of the public data 154 are then merged with the client data 152 to create combined or composite data 156, which is stored in the data storage 134.

The analyzer system 130 then processes and analyzes the combined data 156 through one or more of the statistical models provided by the custom modeler 142. Each statistical model provided or generated by the custom modeler 142 is designed to identify the propensity (likelihood) of each prospective donor to give an annual gift, a major gift, or a planned gift. Preferably, the statistical models are customized based on probit regression analysis, as discussed in greater detail hereinafter, using key variables identified from the combined data that are the most relevant to the non-profit organization. Alternatively, the statistical models are prescriptive based on probit regression analysis, as discussed in greater detail hereinafter, using both industry data and key variables identified from the combined data that are the most relevant to the non-profit organization. The accuracy and reliability of the custom and prescriptive statistical models are tested using composite data of prospective donors not in the pool of prospective donors of the non-profit organization using receiver/operator characteristic, r-squared, and d-prime. At least one statistical model is also designed to identify the capacity or ability of the prospective donor to donate—such donation preferably being an exact dollar figure estimate or an amount falling within one of a plurality of specified ranges. The specific range levels are custornizable by the non-profit organization or by the operators/developers of the analyzer system.

The output of each statistical model is a propensity score for each prospective donor in the pool. Each respective propensity score is indicative of the relative likelihood that the corresponding prospective donor will donate to the non-profit organization as compared to other prospective donors in the pool. A separate propensity score is generated for annual gift likelihood, major gift likelihood, and planned gift likelihood. A separate capacity score is also generated for each prospective donor in the pool. Each respective capacity score is indicative of the financial ability of the corresponding prospective donor to donate to the non-profit organization.

The analyzer system 130 then provides the optimized prospect donor data and recommendations 158 in the form of the propensity and capacity scores for each prospective donor in the pool to the non-profit organization 110. From such data, the non-profit organization 110 is able to target more effectively its requests for donations from the pool of prospective donors.

More details of the first aspect of the present invention are described in section B and D of the Detailed Description of the Invention, hereinafter.

In a second preferred embodiment of the present invention, a method of identifying best prospective donors of a particular planned gift from a pool of prospective donors of a specific non-profit organization is disclosed. Initially, the industry standard modeler 144 develops one or more statistical models indicative of the likelihood of an individual to make a particular planned gift in contrast with other types of planned gifts. Possible planned gifts include bequests, charitable remainder trusts, charitable gift annuities, pooled income funds, and life insurance. Preferably, such statistical models are based on historical data (obtained from public databases 132 and from private databases (not shown)) of a plurality of individuals who have made donations of the particular planned gift to non-profit organizations. The statistical models each have their own plurality of key variables.

The non-profit 110 then provides its raw donor data or client data 152 to the analyzer system 130 for processing and analysis. As previously described, such data 152 is converted in conventional manner to a standardized format, if necessary.

The analyzer system 130 then processes and analyzes the client data 152 through one or more of the statistical models provided by the industry standard modeler 144. Each statistical model provided or generated by the industry standard modeler 144 is designed to identify the propensity likelihood) of each prospective donor to give one of the particular planned gifts.

The output of each statistical model is a propensity score for each type of planned gift wherein each respective propensity score is indicative of the relative likelihood that the corresponding prospective donor will donate to the non-profit organization using the particular planned gift as compared to other prospective donors in the pool and as compared to other planned gift types.

The analyzer system 130 then provides the optimized prospect donor data and recommendations 158 to the non-profit organization 110 in the form of the propensity scores for each prospective donor in the pool for each type of planned gift. From such data, the non-profit organization 110 is able to target more effectively its requests for donations from the pool of prospective donors.

More details of the second aspect of the present invention are described in section C and D of the Detailed Description of the Invention, hereinafter.

B. Prospect Propensity and Capacity

The first aspect of the present invention generally relates to methods and a system for providing a custom, predictive modeling service that identifies the propensity of giving for each prospective donor in a non-profit's database that contains the pool of prospective donors for the non-profit organization. An asset screening system is used to identify indicators of wealth that can be used to estimate a given prospect's capacity to give each type of donation.

As stated previously, the system of the present invention receives client data from a non-profit organization containing information on various prospective donors, such as name, address, and giving history. Typically, this information comes from the donor relationship management database of the non-profit organization. The data is sent to the analyzer system in an electronic format (CD, magnetic media or via the Internet) and usually contains biographical, demographic and giving-related information about each prospect. The data is then prepared for modeling and asset screening. This preparation includes, standardized formatting, address standardization, National Change of Address (NCOA) processing. This information is matched and combined with individual and household demographic and financial data, aggregated credit data, and U.S. census data to create composite data associated with each prospective donor from the pool.

The data is then processed and analyzed by the analyzer system of the present invention using statistical analysis. A more detailed explanation of the statistical modeling process is described in Section D of the Detailed Description of the Invention, hereinafter. Preferably, each prospective donor receives a propensity score that is normalized with a range of possible scores, such as between 0 and 1000. Also, preferably, each prospect receives a separate propensity score for each type of donation. Preferably, there are three propensity (likelihood) scores ranging from 0-1000 (Annual Gift Likelihood, Major Gift Likelihood, Planned Gift Likelihood) and one Target Gift Range score ranging from 0-12. The higher the score, the more the prospect resembles the characteristics of a particular type of donor, and, thus, the more likely that prospect is to give a donation of that type.

After the prospective donor file is scored using the statistical models, the prospects with the highest propensity scores are preferably processed through an additional asset screening service. The number of prospects analyzed with this additional screening service is variable. Due to cost considerations, it may be desirable only to screen a selected number or percentage of the top prospects (based on major gift propensity score, annual gift propensity scores, combined score, capacity score, or any combination of the above). During asset screening, financial, demographic, and biographical information is appended to each prospect record (where matches exist). That information may include work history, personal biography, non-profit affiliations and contributions, federal elections contributions (FEC), compensation data, stock holdings and sales, real estate assets and luxury item ownership.

The propensity and capacity scores and asset screening information (if appended) are combined and then sent to or made available to the non-profit organization. Preferably, such data is sent to the non-profit as a Microsoft MSDE (or similar) database that includes a built-in graphical user interface that enables an end-user at the non-profit organization to search, open, view and edit prospect records, map prospect records, view prospect propensity scores and asset information, query and report on individual or groups of prospect records and export prospect data for uploading into the non-profit's donor relationship management database. Alternatively, such data may be made available through a web-accessible, password-protected, interactive web site in conventional manner.

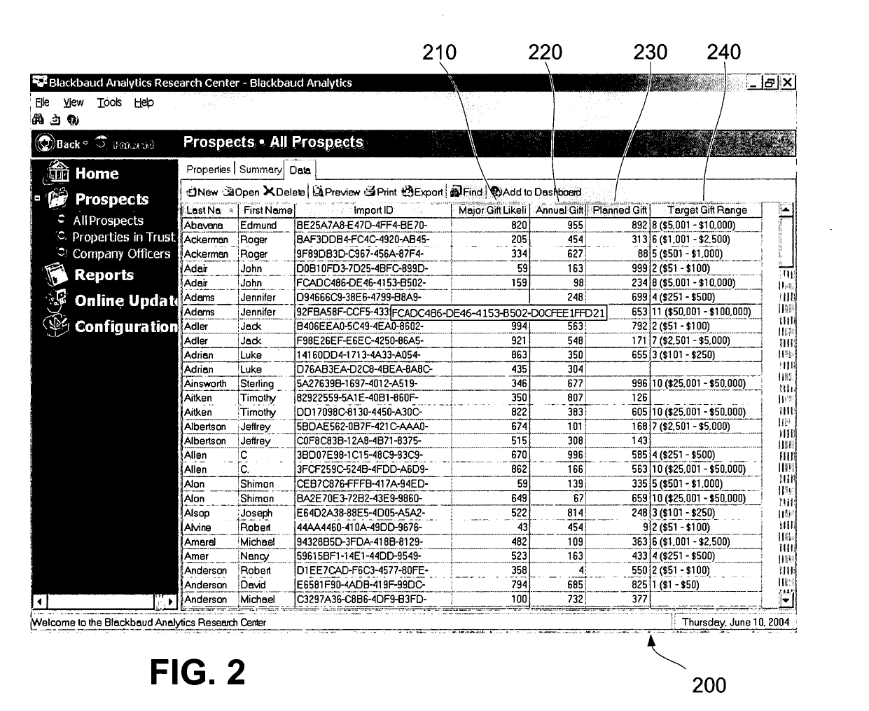

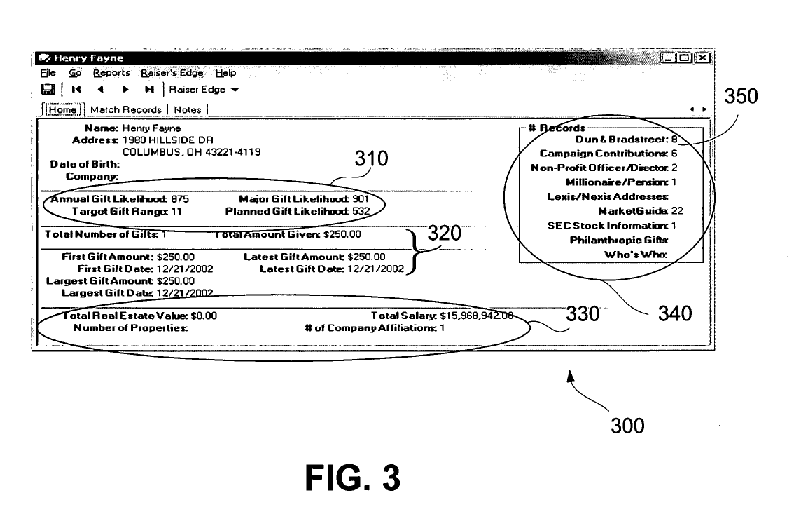

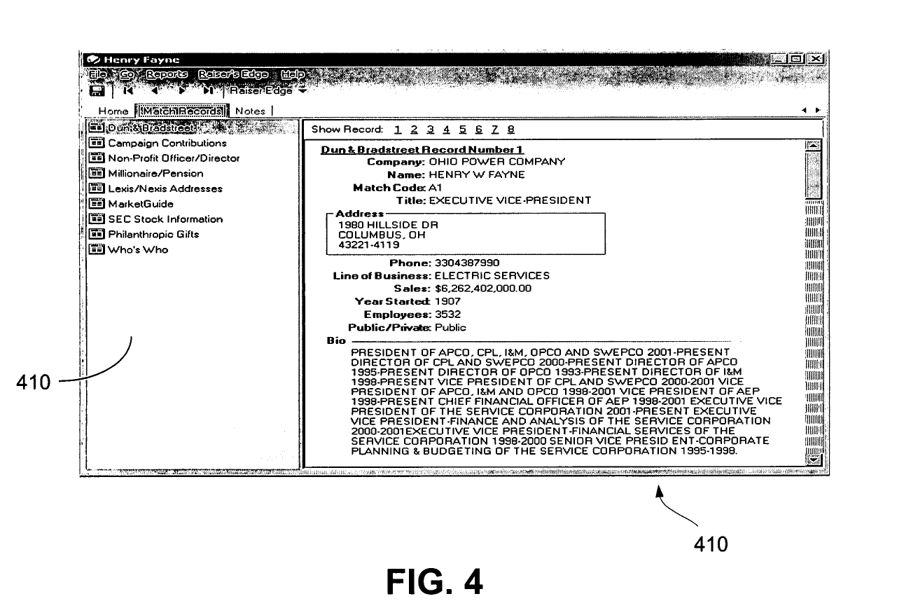

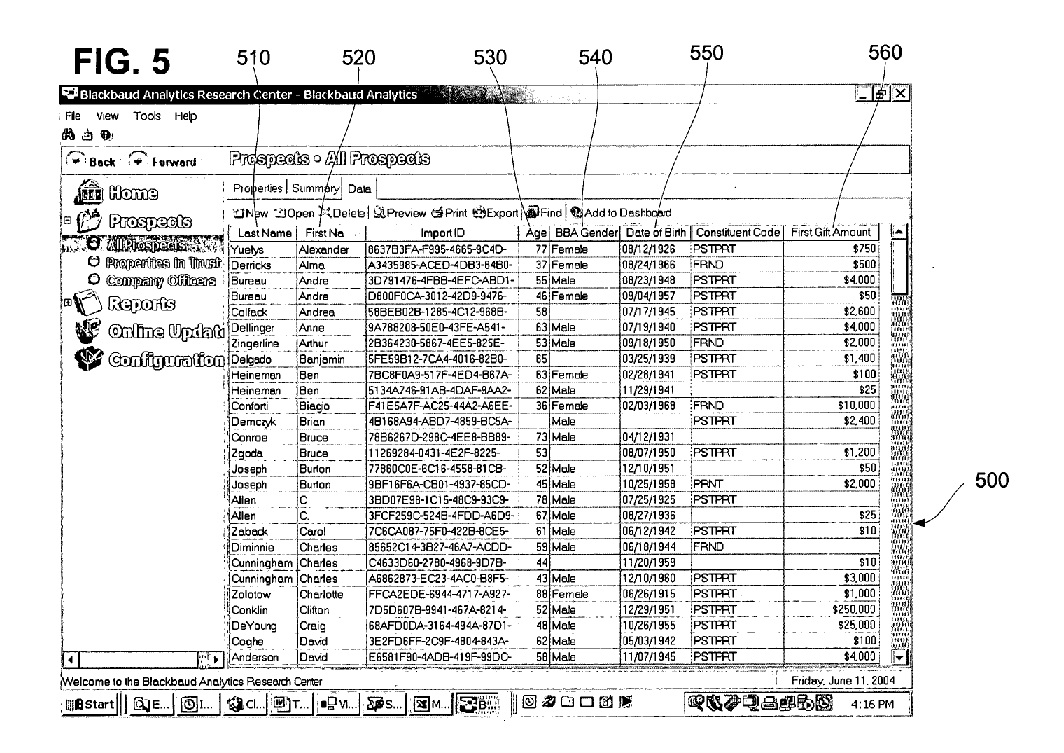

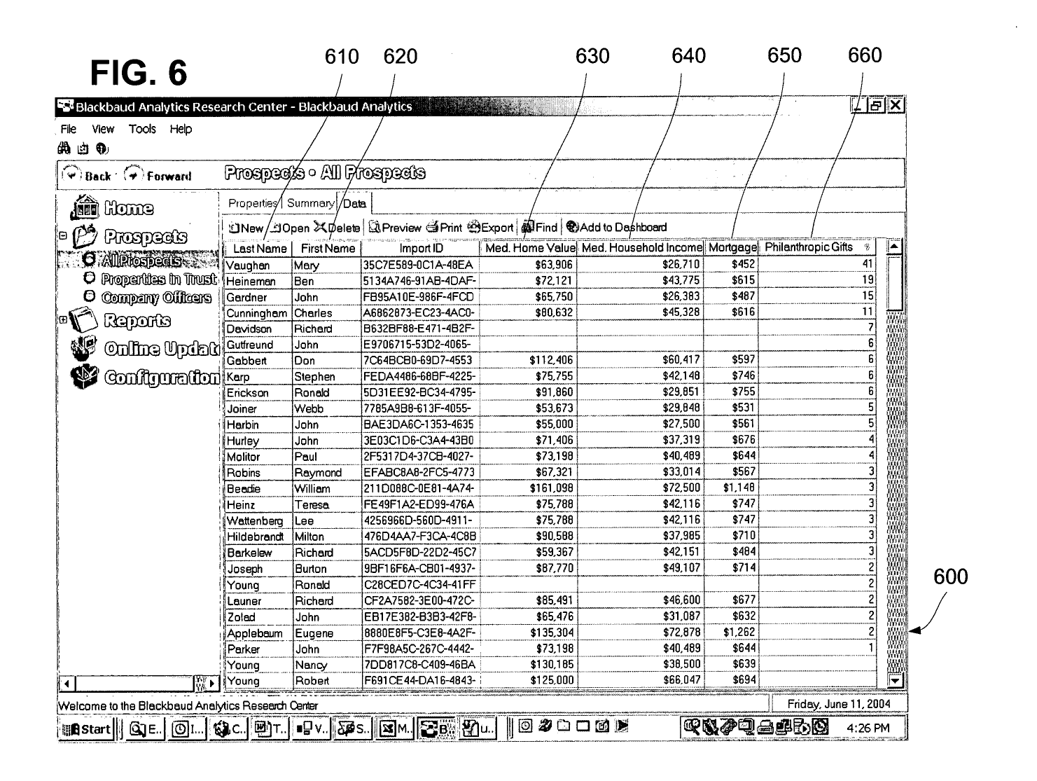

A screen shot 200 in FIG. 2 illustrates a sample list of prospective donors who have been scored for major gift likelihood 210, annual gift likelihood 220, planned gift likelihood 230, and capacity (or target gift range) 240. An individual prospect may be viewed in more detail by selecting such prospect from the list in conventional manner. Screen shot 300 in FIG. 3 illustrates such a more detailed view of one prospective donor. As can be seen, propensity and capacity score 310 are shown, as well as historical data 320, and asset screening information 330, 340. Any of the asset screening information can be viewed in greater detail as well by selecting such record in conventional manner. One such more detailed view of a selected asset screening search is shown in screen shot 400 in FIG. 4. Specifically, FIG. 4 illustrates one of the Dun & Bradstreet records 350 identified in FIG. 3. Folder list 410 in FIG. 4 identifies the same records that were identified in asset screening information area 340 from FIG. 3. Screen shot 500 in FIG. 5 illustrates sample client data obtained from a non-profit's own database of prospective donors. Such client data includes name 510,520, age 530, gender 540, date of birth 550, first gift amount 560, other giving history, and the like. Screen shot 600 in FIG. 6, in contrast, illustrates external or public data that is obtainable for prospective donors, but which is not usually maintained or necessarily known by the non-profit organization. Such public data that is accessible for free or for a fee includes name 610,620, median home value 630, median household income 640, mortgage 650, number of philanthropic gifts 660 given by the prospect, and the like. Such data may be specific to the prospect (e.g., from credit reports) or may be census data that indicates the median or average values for individuals living in the prospect's zip code.

The propensity scores and asset screening information are then used by the non-profit organization development staff to segment its database into its best prospective donors.

C. Targeting Planned Gifts

The second aspect of the present invention generally relates to a system and methods for identifying the best planned giving vehicle to solicit from each prospective donor in the non-profit's database. Using statistical models, based on over 100,000 individuals from over 40 non-profit organizations, the present system predicts the likelihood that a prospective donor will give one of five (5) different types of planned gifts, including bequests, charitable remainder trusts (CRT), charitable gift annuity (CGA), pooled income fund (PIF), and life insurance policies. These models provide a non-profit organization with a more accurate way to segment their database according to those prospective donors most likely to make a specific type of planned gift. Such segmentation enables non-profits to send different marketing messages or solicitation packages to each segment, reducing expensive mailings and increasing the efficiency of their marketing efforts.

For example, prospective donors who have high CRT likelihood scores, meaning they have the characteristics of someone likely to establish a CRT, are targeted to receive a brochure outlining the benefits of establishing a CRT. Prospective donors who have high CGA/PIF likelihood scores are targeted to receive a brochure outlining the benefits of a contributing to the organization's Pooled Income Fund or Charitable Gift Annuity. The response rates for each mailing increases since individuals are no longer confused by the vast array of options and since they are receiving planned gift information that is most relevant to them. Also, the expense of a fundraiser mailing is dramatically decreased. The brochures are smaller and the number of brochures mailed has decreased, since the organization can now mail to only those individuals most likely to give that specific type of planned gift. By better understanding the audience they are trying to reach and using market segmentation, non-profit organizations are able to improve the efficiency and effectiveness of their planned giving programs.

As stated previously, the system of the present invention receives a file from a nonprofit organization containing information on their prospects, such as name, address, and giving history. This information is matched up against individual and household demographic and financial data, aggregated credit data and U.S. census data. This data is then processed through a separate Bequest Likelihood model, a Charitable Remainder Trust Likelihood model, Charitable Gift Annuity/Pooled Income Fund Likelihood model, and the Life Insurance Likelihood model. Each prospect receives 4 scores based on these models. The scores are preferably normalized between a range of 1 and 1000. The higher the score the more the prospect resembles the characteristics of individuals who make the specific type of planned gift and, thus, the more likely that prospect is to give that type of planned gift. For example, a prospect who is over the age of 75, has been consistently giving to the organization, and has low credit card debt, has the characteristics of a CGA\PIF giver, according to a preferred CGA\PIF model of the present invention. This person would therefore receive a score closer to 1000 by applying the CGA\PIF Likelihood model. Someone younger, with higher income levels, but lower home values would receive a lower CGA\PIF score, but a higher Life Insurance Likelihood score. Since the scores range from 1 to 1000, the planned gift scores can be easily used by the non-profit organization development staff to segment its database in the way that is most beneficial to the non-profit. If the organization has a small fundraising staff, they can choose to only actively pursue the 50 individuals with the highest Bequest Likelihood and the 50 individuals with the highest CGA/PIF scores. Organizations with larger fundraising staffs, could choose to go do a large segmented mailing to all those individuals who have a score of 800 and above in any of the type of planned gift models.

Utilizing information on over 100,000 individuals and 9,000 planned gifts from over 40 nonprofit organizations, statistical models were built predicting the likelihood to give each type of planned gift versus all other planned gifts. The models were built using 358 variables. These variables included individual and household demographic and financial information, aggregated credit data at the zip plus 4 level and aggregated 2000 and 1990 census data. A more detailed explanation of the statistical modeling process is described in Section D of the Detailed Description of the Invention, hereinafter.

Each of the specific planned gift types and models associated therewith will now be described and discussed in greater detail, as follows.

1. Bequests

A bequest is an endowment that is granted through a will. A bequest can be a specific sum, a percentage of an estate, or the remainder of an estate after expenses. Bequests can include cash, securities, real estate, houses and personal property such as valuable collections, art, or jewelry. For most nonprofit organizations the largest source of planned gifts is bequests, yet only 10% of realized bequests are typically identified by most non-profits.

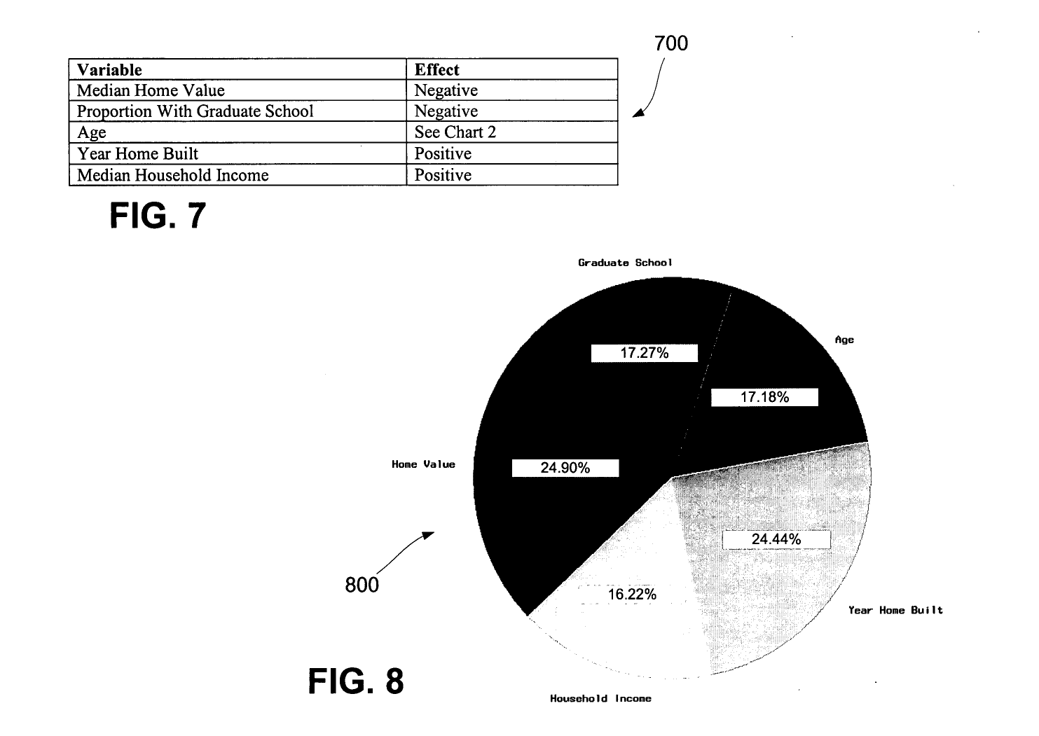

The Bequest Likelihood model of the present invention was designed using data on over 4000 gifts of bequests to a large variety of non-profit organizations. Probit regression analysis was used to find the characteristics of those individuals most likely to make a bequest (versus another type of planned gift). The variables and their effect on the Bequest Likelihood model are shown in table 700 of FIG. 7 and their relative (0/%) importance compared to the other key variables is shown in chart 800 of FIG. 8.

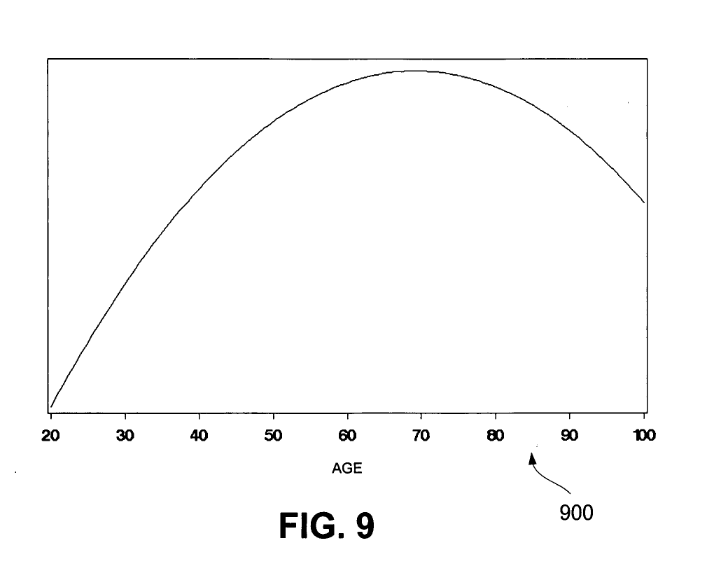

As shown in graph 900 of FIG. 9, the Bequest Likelihood model indicates that individuals most likely to make a gift of a bequest are between the ages of 55 and 80 with the likelihood of making a bequest increasing up to age 70 and decreasing after that. These individuals also tend to live in areas where the education level is lower than other types of planned gift givers, and home values are lower. On the other hand, bequest donors live in areas where the median income level is higher than other types of planned gifts, indicating that bequest donors are slightly younger and thus more likely to live in areas where individuals are still employed. The fact that they live in areas with newer homes also corresponds to the fact that bequest donors are younger than other types of planned gift givers.

2. Charitable Remainder Trusts

A charitable remainder trust (CRT) is an irrevocable trust designed to convert an investor's highly appreciated assets into a lifetime income stream without generating estate and capital gains taxes. CRT's have become popular in recent years as they not only represent a valuable tax-advantaged investment, but also provide a gift to one or more charities that have special meaning to an individual.

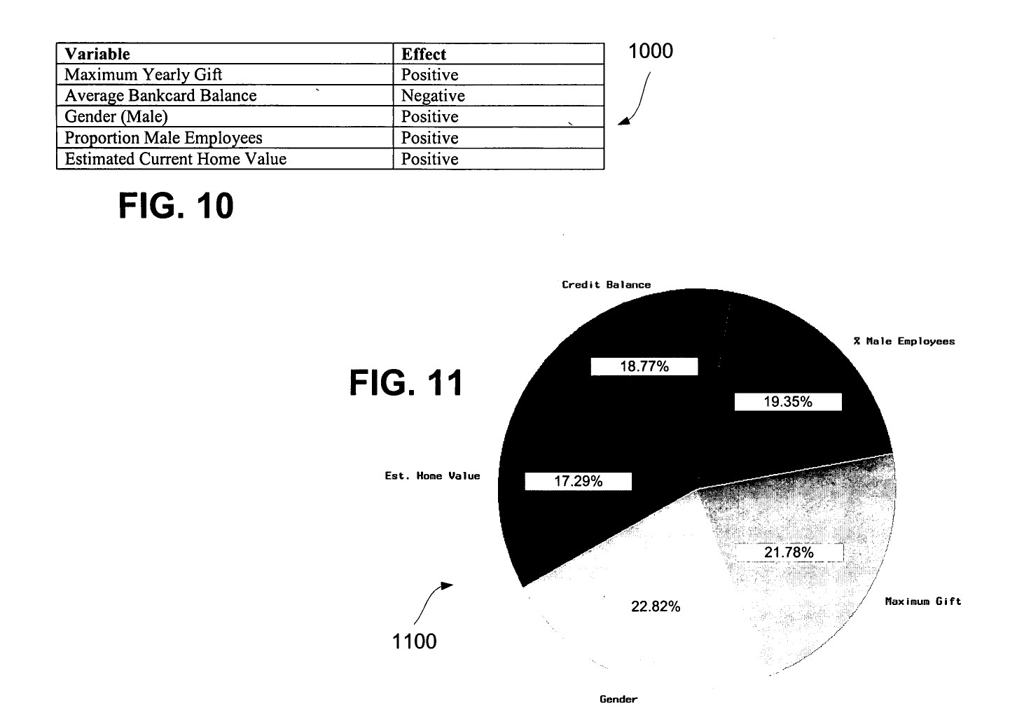

Utilizing data from over 40 non-profit organizations and over 700 established CRT's, probit regression analysis was used to build a model which captured the characteristics of those most likely to establish a CRT. The variables and their effect on the Charitable Request Likelihood model are shown in table 1000 of FIG. 10 and their relative (% o) importance compared to the other key variables is shown in chart 1100 of FIG. 11. The model indicates that individuals most likely to establish a CRT are those that have made large gifts to the nonprofit organization in the past, showing both a strong affinity for the organization as well the capacity to make a large gift. The model indicates that wealthy, fiscally conservative males, living in traditional neighborhoods, where more males than females are in the work force are also more likely to establish a CRT.

3. Charitable Gift Annuities and Pooled Income Funds

A charitable gift annuity (CGA) is a giving plan that appeals to many who cannot give in amounts large enough to warrant a separate trust. A CGA makes fixed annual payments of principal and interest for life to whomever the giver names. A CGA is designed to make the promised annual payments for the life of the annuitant(s) and to provide at least 50 percent of the original gift to be used by the charity at the donor's death.

A pooled income fund (PIF) agreement provides for the transfer of assets into a pooled trust that will belong to the charity. Donors transfer assets as gifts that are made a part of a pooled fund out of which the trustee distributes to the giver a pro rata share of the income earned from the fund's investment. Upon the deaths of those who receive the income, their shares in the pool become gifts to the charity.

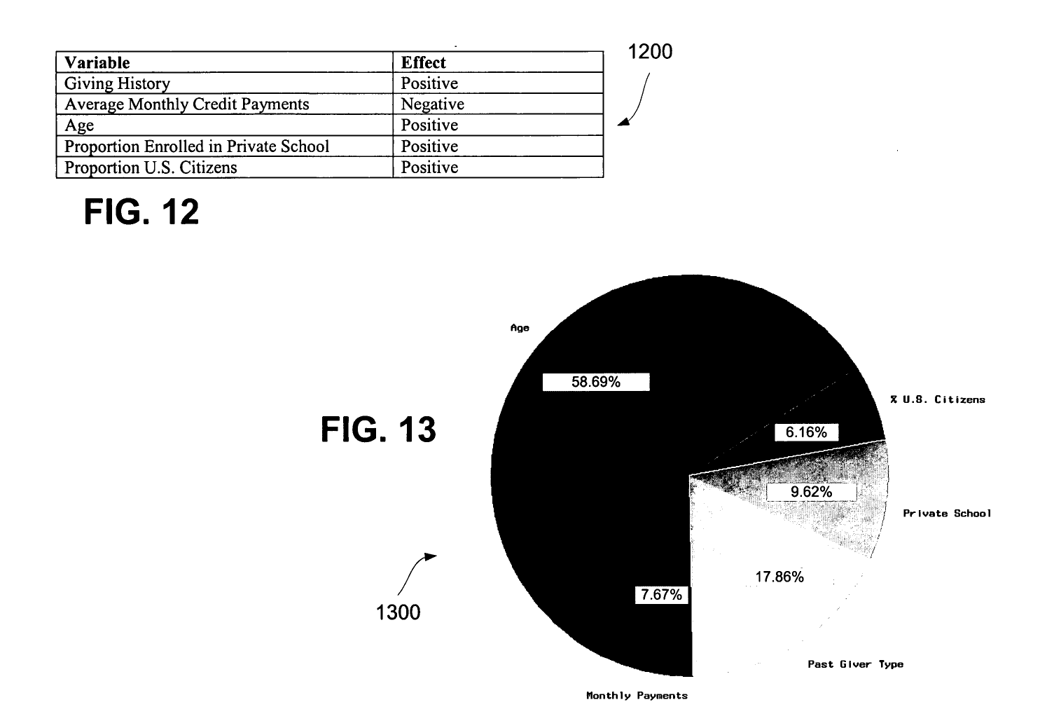

Utilizing data from over 40 nonprofit organizations, 700 Charitable Gift Annuities and over 200 gifts to a Pooled Income Fund, probit regression analysis was used to build a model which captures the characteristics of those most likely to give to a CGA or PIF. The variables and their effect on the resulting CGA/PIF model are shown in table 1200 of FIG. 12 and their relative (%) importance compared to the other key variables is shown in chart 1300 of FIG. 13. The CGA/PIF likelihood model shows that fiscally conservative, older individuals who have been consistently giving to the organization, not necessarily in large amounts, are most likely to give through a CGA or PIF.

4. Life Insurance

With approximately 400,000,000 life insurance policies exceeding $12 trillion, life insurance is one form of deferred planned gifts that has enormous potential for helping fund charitable organizations. A donor can purchase a new life insurance policy naming the charity as the beneficiary or name the charity as a beneficiary of an existing life insurance policy. Life insurance gifts allow an individual to provide a large gift for a modest premium. The premium payments are deductible by the donor if the charity is the irrevocable owner and beneficiary of the policy. Favorable gift and estate tax consequences may also result from such a gift.

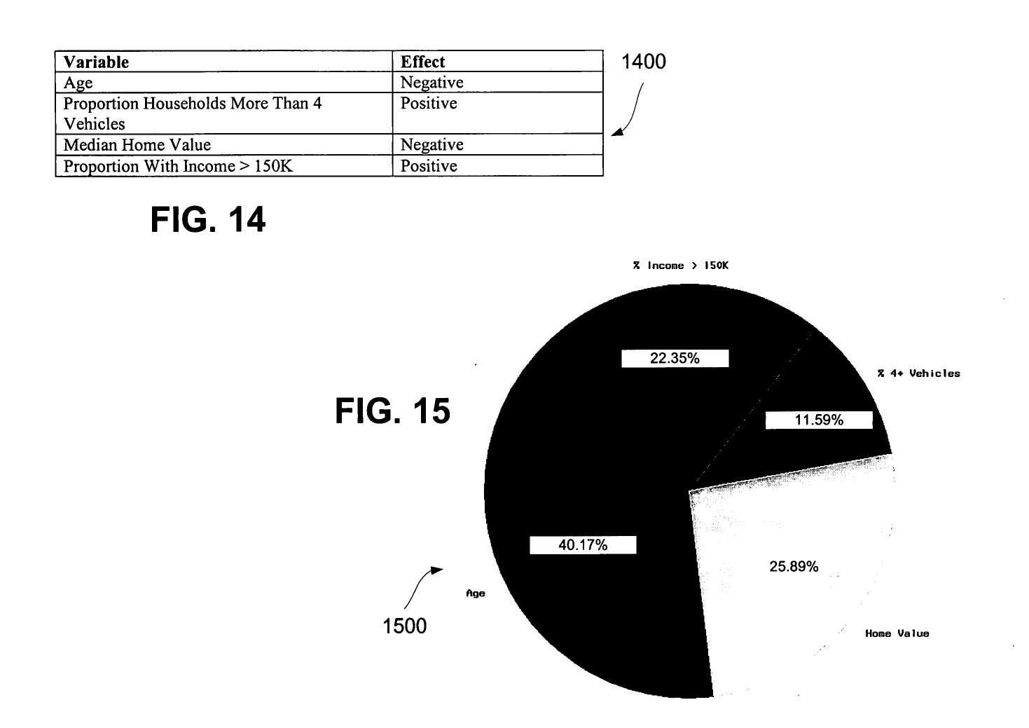

Utilizing data from over 40 nonprofit organizations and over 250 gifts of a life insurance policy, probit regression analysis was used to predict the likelihood of contributing a life insurance policy versus other types of planned gifts. The variables and their effect on the resulting Life Insurance Likelihood model are shown in table 1400 of FIG. 14 and their relative (% o) importance compared to the other key variables is shown in chart 1500 of FIG. 15. The Life Insurance Likelihood model shows that of the planned gift givers, life insurance givers are young individuals with larger families, higher incomes, but lower assets.

D. Development of Statistical Models

1. Introduction

Response modeling is a common data mining technique in direct marketing. Numerous studies have examined ways to improve the efficacy of a direct mail campaign using response models. The effectiveness of response models in direct mail campaign have met with relatively limited success. Much of this is due to the fact that most for-profit direct mail campaigns must use purchased lists of names that have limited information about each prospect and little association with the organization.

Nonprofit organizations have a distinct advantage over for-profit organizations because they often have built-in prospect pools and thus do not need to rely as much on purchased lists of names. Many nonprofit organizations have large prospect pools through memberships, in the case of museums and some foundations, past-patients in the case of hospitals and alumni, parents of alumni and students in the case of schools. The advantage of prospect pools, such as these, is that they are continually increasing, and the organization may have quite a bit of information about each prospect.

Universities, for example, often times have information about an individual's age, gender, relationship to the school, major, and degree, which are generally strongly correlated with the propensity to make a donation. They could also purchase information, such as income, home value, age, gender, etc. about the individuals on their database. It is difficult to synthesize these bits of information into one campaign strategy.

Building a response model utilizing this information enables a nonprofit organization to combine the many characteristics of their givers into one score that can be used to rank each prospect's likelihood to make a charitable contribution.

Using data from a private Catholic high school, this section of the Detailed Description of the Invention describes one exemplary methodology for building a response model that captures the characteristics of those individuals most likely to make an annual gift. A similar methodology may also be used to develop a response model for other types of gifts, as have been described previously. The methodology presented is efficient enough to handle many potential independent variables, while fully utilizing the rich data available to many organizations. The process uses an Empirical Bayes method for transforming categorical variables such as postal code and major, which because of the large number of categories, are typically difficult to use in a regression analysis, into continuous numeric variables that can be utilized in a regression. The process is also able to capture non-linear relationships, such as quadratic relationships, between the independent variables and the propensity to give to an organization.

2. The Methodology

The data utilized in the present example comes from a small, private, Catholic high school in the Northeast region of the United States. The high school has a database of 10,828 individuals. For each individual the high school has provided six years of giving history, which has been annualized. The goal is to produce a model that identifies individuals who are likely to give based on their characteristics. The dependent variable is based on information from the most recent year of giving. A “giver” is defined to be someone who gave an annual gift in the most recent year. Individuals who gave are therefore coded as a “1” and individuals who did not give in the most recent year are coded as a “0”. A probit regression is used to model the likelihood that an individual gave in the most recent year.

The high school has information on every individual's age, class year (if they are alumi), gender, and the relationship of each individual to the school, i.e., alumnus, parent, friend, etc. In addition to these data elements, the high school's data are overlaid with credit and census data. The overlaid credit data provides information about each prospect's income and wealth, with variables such as mortgage and auto loan information, estimated home value, and use of premium and upscale retail bankcards.

The census survey data is aggregated at the block group level (about 300 households) and provides information such as average monthly mortgage, average yearly income, education level, family size, and religious affiliations. With the overlaid credit and census variables, plus the data provided by the school, over 100 variables are utilized in the modeling process.

After overlaying the high school's database with the credit and census data, the data set is split into two halves for model validation. “Validation” refers to the process of confirming the efficacy of a model as applied to a data set that is independent of the data used to build the model. By setting aside a portion of the high school's data, generally called the “hold-out sample”, the models can be tested to see which models perform at the optimal level. The validation process is discussed further below.

Probit analysis restricts relationships between the independent and dependent variable to be linear. To capture non-linear relationships several transformations of the independent variables are done. To do this, the independent variables are categorized into three types of variables and transformed according to these types. The three types of variables are categorical variables, such as constituency code and postal code; continuous numeric variables such as age and income; and dummy variables such as gender and presence of a mortgage. Categorical variables are transformed using an Empirical Bayes method, utilizing the hold-out data set. Standard numeric variables are transformed in two ways to account for any possible quadratic relationships and to normalize any variables with a highly skewed distribution. Dummy variables are created on such variables as whether an individual has a mortgage, by transforming them so that any individual who has a mortgage receives a “1” and individuals who do not have a mortgage receive a “0”.

A common transformation of categorical variables such as constituent code requires the creation of several dummy indicator variables for all but one of the categories. However, variables, such as postal code and major, have far too many categories to create a dummy variable for each category. In order to utilize these variables in a probit analysis categorical variables are transformed into numeric values using an Empirical Bayesian method.

The intuition behind the Bayesian method is quite simple. A variable such as postal code is converted into a numeric data element by first determining the proportion of individuals who made a donation in the most recent year for each postal code. If postal code 80005, for example, contains 100 prospects 50 of who made a donation, then those individuals residing in postal code 80005 receive a numeric value of 0.50.

It is possible to use this proportion of givers in each postal code in a regression analysis; however this transformation has problems. For postal codes with a large number of prospects, it is likely that the proportion of givers in the database is representative and may be used to infer the likelihood of any individual to give in that postal code. However, for postal codes with few prospects, it is unlikely that the proportion of givers in the database is representative.

It is desirable therefore to “weight” those postal codes with fewer prospects different than those postal codes with a large number of prospects. Using an Empirical Bayes method described in Morrison and Casella the proportion of individuals who gave in a particular postal code is shrunk towards the overall mean for the entire database. The amount of shrinkage depends on the number of prospects in each postal code.

In Bayesian data analysis the researcher's prior knowledge of the problem at hand is incorporated into the statistical analysis. In this case the overall percentage of givers on the hold-out data set is used as the prior. The prior is then combined with the actual observed percentage of prospects who have given within each postal code, on the hold-out data set. The manner in which the prior and the actual percentage of givers is combined depends on the number of prospects in a given postal code. The fewer the prospects in a postal code the more weight is placed on the prior and the less weight placed on the actual percentage of givers in a postal code. Thus for postal codes with fewer prospects more shrinkage towards the mean occurs. In this case the mean is the overall percentage of givers on the hold-out data set.

Note that the Empirical Bayesian method is modified slightly here, to avoid “peeking” at the data prior to building the model. By creating the numeric transformations of the categorical variables on the hold-out data set and then applying those numeric transformations to the model building data set peeking at the data prior to building the model is avoided and thus the possibility that the categorical variables will be falsely predictive is avoided.

The categorical variable transformation does have a drawback in that it does not capture the possible ordinal relationship of some categorical variables. Postal codes, for example, may also be used to measure distance from an organization, which is likely to be a determinate of propensity to make a donation. Certainly an individual living close to a museum is more likely to donate to that museum than someone living 1000 miles away. However, in the method described above those postal codes closer to the organization will receive a higher numeric transformation than those further away, provided that there is a relationship between giving and distance from the organization.

The Empirical Bayes transformation described above has the added advantage of allowing for other relationships between geography and the likelihood to give. For example, if an analyst wanted to build a model that predicts individuals most likely to make a planned gift, it is conceivable that individuals who live in areas more populated by retirees are more likely to make a contribution. In this case then, the postal codes with the highest numeric transformations may not be those closest to the organization but rather those in states such as Florida and Arizona where there are larger numbers of retired individuals. The Empirical Bayesian transformation described above is able to capture these types of relationships.

3. Continuous Numeric Variables

Probit regression restricts the relationship between the independent variables and the dependent variable to be strictly linear. That is, the likelihood to give is assumed to be either always positively related to the explanatory variable or always negatively related to the explanatory variables. Yet some variables, such as age, may not exhibit a strictly linear relationship with the propensity to make a donation.

In some instances the relationship can be quadratic in nature. For example, it is possible that the likelihood to donate to an organization increases with age up until an individual retires. Upon retirement the individual is now faced with a fixed income and thus has fewer resources available for charitable contributions. Thus, around 65 years old, the relationship between age and giving might become negative.

To capture possible quadratic relationships such as these, a variable is created that includes the quadratic nature in its scope. This is done by regressing the independent variable and the square of the independent variable on the likelihood to make a donation, using the hold-out data set. The coefficients from this regression are then used to create a new variable in the model building data set. For example, regressing age and age squared on giving in the most recent year for the Catholic high school, yields the following regression equation:
Y=−0.267+0.00226(AGE)+−0.00247(AGE2).
This regression equation is used to create a new variable with the quadratic relationship built in. For a person who is 30 years old the value for the new variable is −2.35, for a person who is 50 years old the value for the new variable is 3.81 and for a person who is 80 the value is −15.89. The equation indicates that the relationship between giving and age appears to be increasing up until age 50 or so and then decreasing after that.

Similar to the creation of the categorical variables, these quadratic relationships are built on the holdout data set, and applied to the model building data set, so that we do not run the risk of creating variables that are highly correlated with the dependent variable merely because we have “peeked” at the data. Additionally, logged values of all continuous variables are created in case any of the independent variables are highly skewed, as is often the case with variables such as income.

4. Model Creation

After transforming and creating all of the variables there are more than 170 potential independent variables. Many of these variables are highly correlated with one another, particularly the logged, quadratic, and standard numeric forms of the same variable. The highly intercorrelated variables can lead to problems with multicollinearity, which occurs when the independent variables are highly correlated and can lead to severe estimation problems.

It is also extremely time-consuming to build models using this many variables, many of which may have no correlation with the likelihood make a donation. For these reasons the number of potential variables in the final model is limited by examining the simple correlations between the independent variables and the dependent variable.

During this step, the correlations of the logged, quadratic and standard numeric forms of each variable are examined, and the form that has the highest correlation with giving is kept for the final modeling stage. The intercorrelations of the independent variables are also examined to avoid problems with multicollinearity. Variables such as average household income and median household income are highly correlated and thus only one will be chosen for the final modeling stage. The 50 variables that are most correlated with the dependent variable are kept for the modeling process, taking into account the intercorrelations among the independent variables.

Using the best subset option in SAS the best one to ten variable models are built using the 50 variables kept from the correlation analysis. The “best subset” option in SAS builds the best one variable model, by building all of the possible one variable models, but choosing the model yielding the highest residual chi-square statistic. The best two through ten variable models are created in a similar way.

5. Model Validation

Once the best one through ten variable models have been determined by SAS, the performance of each of these models is examined using the hold-out data set. Since, the goal is to predict future giving, it is important to ensure that the models do not suffer from “over-fitting,” which occurs when too many variables are included in the model. Models that are over-fit perform very well in-sample; since model performance generally increases as more variables are added. By examining each model on an “out-of-sample” data set, where performance is best with a modest number of variables and declines when too many or too few variables are included, the problem of “over-fitting” is avoided.

To examine out-of-sample model performance, the predicted likelihood of giving a gift is compared with the actual outcome on the hold-out data set. Measures adopted from signal detection theory, including the Receiver Operator Characteristic (ROC) and d′, are employed. The ROC compares the actual outcome in the hold-out data set to the predicted outcome for all possible criterion scores by examining the tradeoff between “hits” and “false alarms.” Any model score can be used as a cut-off or criterion point, which defines a hit and false alarm rate.

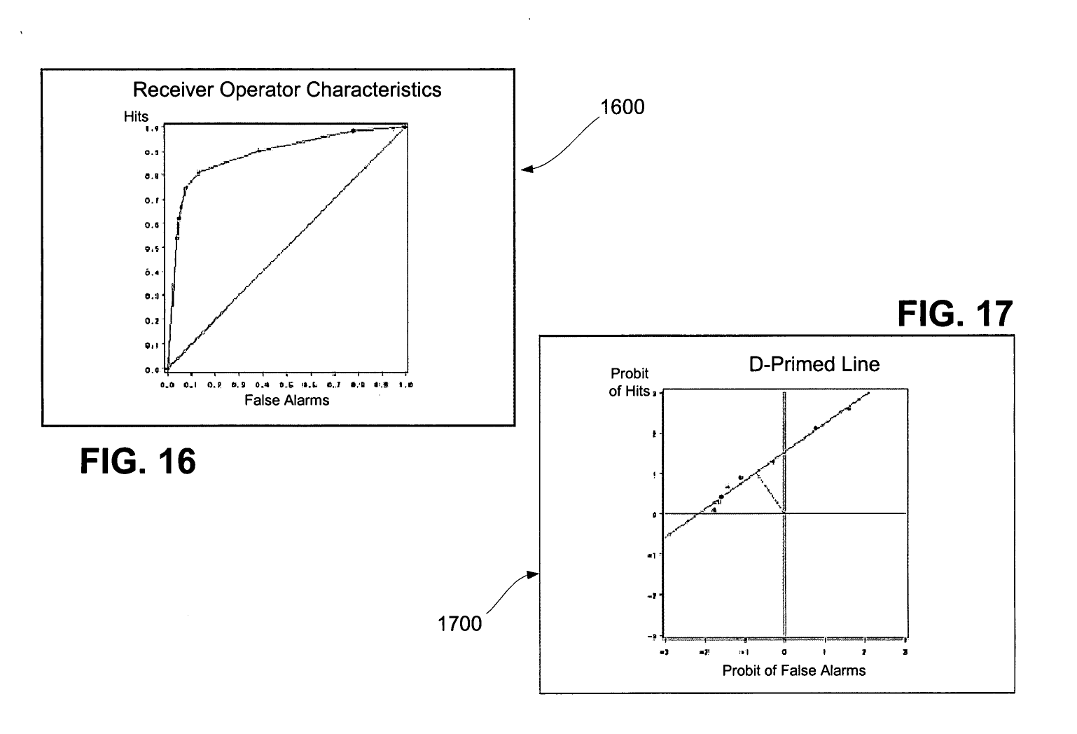

Hits occur when prospects gave in the previous year and were given a score equal to or greater than the cut-off point. False alarms occur when prospects did not give in the previous year and were given a score equal to or greater than the criterion. When models are performing above chance, the hit rate will be greater than the false alarm rate for any criterion score. The hit and false alarm rates for the seven variable model are illustrated in a ROC graph 1600 in FIG. 16. The diagonal line indicates chance performance; the bow above it indicates the performance of the model. The more predictive the model, the more the bow sweeps towards the upper left corner of the graph.

By taking the probit of the hit and false alarm rates, the axes are rescaled and the bows “straighten out” (see graph 1700 in FIG. 17). D′ indicates the number of common standard deviations separating the score distributions for the givers and non-givers. D′ can be calculated by taking the distance between the tangent of the straight line and the origin.

The d′ is calculated using the hold-out data set for the one through ten variable models, to determine which model is most predictive. The d′ for the one through ten variable models built on the Catholic high school's data ranged from approximately 1.23 to 1.25, indicating that about 1.2 standard deviations separate the distribution of givers from the distributions of non-givers. Based on the d′ and the chi-square statistics for individual variables in the models, the seven variable model was chosen. Table 1900 in FIG. 19 shows the final model chosen.

The strongest variable in the model is the number of years a prospect has given gifts in the past. In this instance those that are most likely to give are most likely to have consistently given in the past—this is an outcome that, not surprisingly, is frequent.

The significance of the City and State variable illustrates the effectiveness of the Bayesian transformation on large categorical variables. A variable such as this is difficult to use in a regression analysis because the number of categories makes it difficult to transform into several dummy indicator variables. Using the empirical Bayesian method described above makes it possible to fully utilize this important information in a regression model.

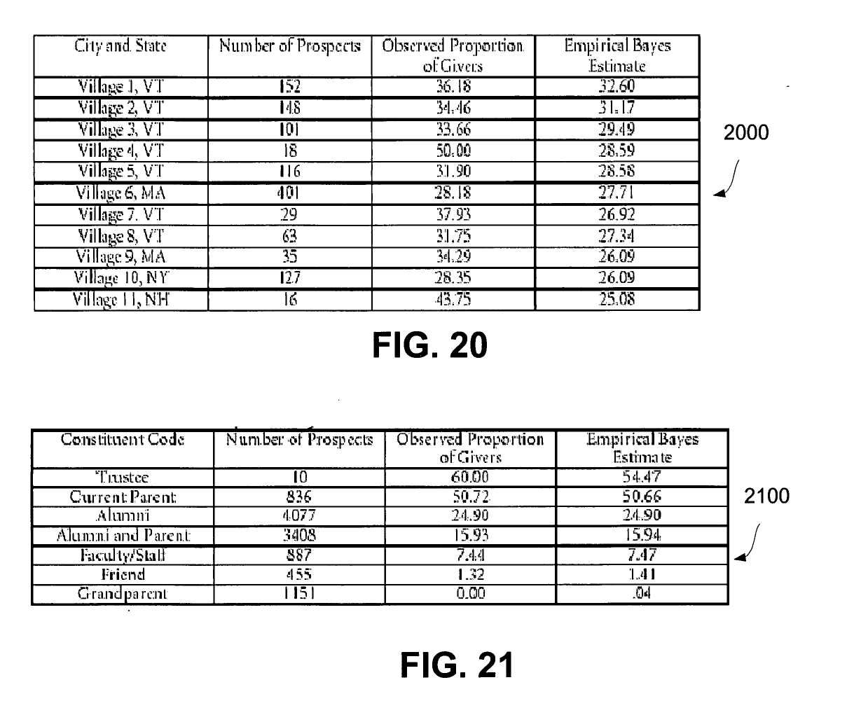

Table 2000 in FIG. 20 illustrates the transformation of this variable. The third column gives the observed proportion of individuals in a city and state who gave to the organization. The fourth column shows the Empirical Bayes estimates of the same proportion. Note that for cities with very few observations, such as Village 4, the Empirical Bayes estimate is much closer to the overall proportion of givers cities with a large number of prospects. Table 2100 in FIG. 21 illustrates the Empirical Bayes estimates of constitute codes.

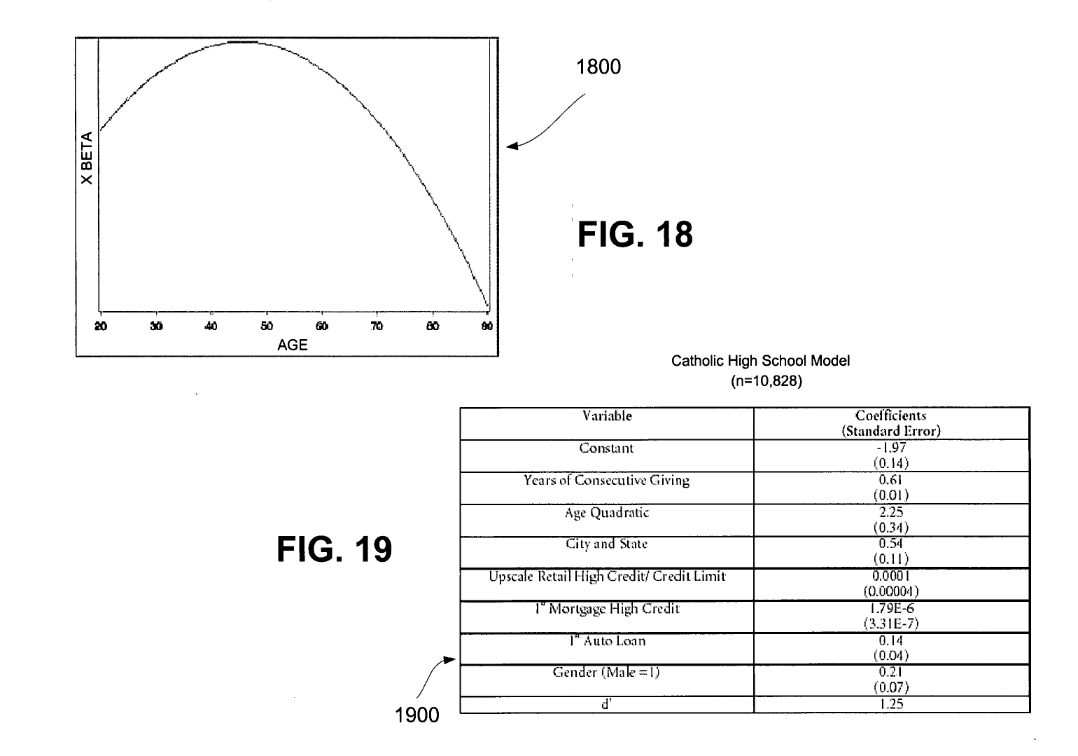

Age is also an important variable in the propensity to give and shows the ability of the methodology to capture non-linear relationships between giving and the independent variables. The relationship between age and the likelihood to give is quadratic. Graph 1800 of FIG. 18 shows this quadratic relationship. Graph 1800 indicates that the likelihood to give increases with age up until around 50 years of age, and then declines. This shows that individuals with children of high school age have a propensity to give to this Catholic high school.

Income appears to be another strong indicator of the likelihood to make a gift to this private high school. The Upscale Retail High Credit/Credit Limit indicates that individuals who are more likely to give have access to upscale retail credit cards, which is indicative of higher income individuals. The likelihood that an individual will make a donation also increases as the individual's mortgage amount increases. The model also indicates that individuals with at least one auto loan are more likely to make a charitable contribution to this high school. These three income-related variables are positive and significant, indicating that the likelihood to give to this private Catholic High School increases with income.

Finally, the positive sign on the dummy gender variable indicates that males are more likely to make a gift than females.

6. Application to Other Organizations

To examine how well the process described here works on different types of nonprofit organizations, a model predicting the likelihood to make a charitable donation has been built for a large metropolitan museum in the mid-western region of the United States. This organization has 160,484 individuals on their database; 4,233 of which have given a gift in the most recent year. The museum has provided information on the length and level of museum memberships, museum interests of every individual, whether the individual has been on a museum sponsored trip, committee participation, and number of children.

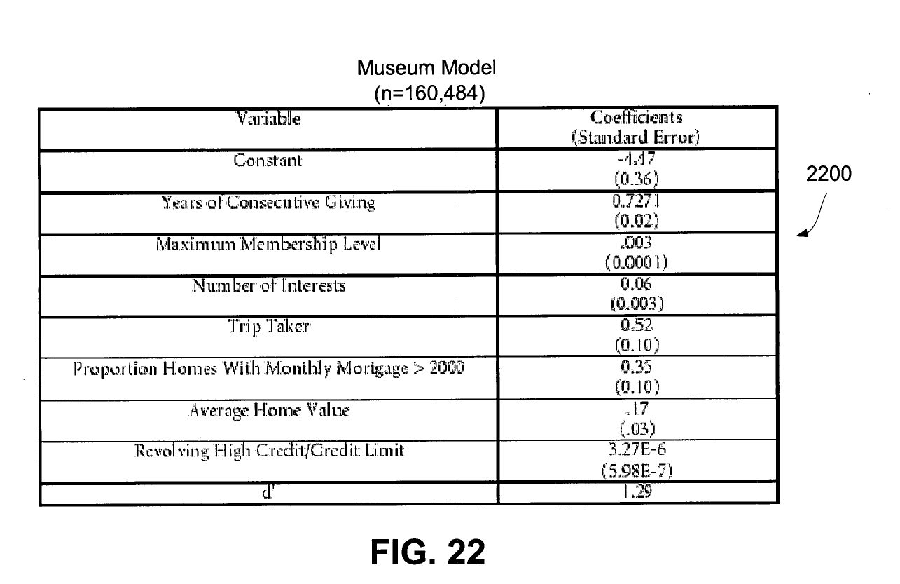

The museum's data was overlaid with the same credit and census data that were overlaid on the Catholic high school's data file and the model was built using the methodology outlined above. After examining the best one through ten variable models, a seven variable model was chosen. The d′ for this model is 1.29, which is similar to the d′ for the Catholic high school's model above. The model, described in Table 2200 of FIG. 22, indicates, not surprisingly, that the museum's donors look quite different than the Catholic high school's donors. The museum's donors are individuals who have a strong association with the museum through membership, who have strong interests in certain types of exhibits and who have been on one of the trips offered through the museum. In other words, donors have a strong affiliation with the museum.

The model also indicates that the likelihood to donate a gift increases with a person's wealth. Propensity to give increases with estimated home value and with the proportion of households in a block group with monthly mortgage amounts greater than $2,000, indicating that donors live in areas with greater home values. The Revolving High Credit/Credit variable indicates that donors have more access to revolving credit than non-donors.

In contrast to the model built for the Catholic high school, where age was a significant factor in the likelihood to give a donation, the museum's donors do not appear to differ in age from the museum's non-donors. This is likely because a museum appeals to a large variety of ages, while a Catholic high school appeals to individuals with high school age children.

7. Brief Comparison with Other Techniques

Tree generating techniques, such as CHAID and CART, have been widely used for the purpose of predicting response to some sort of solicitation. CHAID or Chi Square Automatic Interaction Detector can be applied to situations where all variables, dependent and explanatory, are categorical. At the initial stage a contingency table is built for the response variable with each explanatory variable. By choosing the most significant contingency table, as measured by the Bonferoni adjusted p-value of the corresponding chi-square test, the best first variable is selected and the best combination of categories. The file is split according to the first variable and then another contingency table is built for each node. The process continues until the resulting tree is a certain size. CART and CHAID are both useful techniques to identify important variables and significant interactions that can then be used in a probit regression.

One of the biggest disadvantages to the CHAID technique is that all explanatory variables must be categorical. Therefore, the researcher must decide how to split continuous variables into categorical variables prior to analysis. Often times these decisions are completely arbitrary. With large numbers of variables, many of which are continuous, the use of CHAID becomes quite cumbersome.

CART is another tree generating technique that addresses the limitations of CHAID. CART stands for Classification and Regression Trees. CART examines splits of the form X<C where C is some real number ranging from the minimum value of X to its maximum value. For example, if X stands for the individual's age, and C is 60, then “splitting on X<60” means that all individuals less than 60 years old go to the left and the rest go to the right. One of the advantages of CART is that the data is allowed to decide how to split continuous variables without any arbitrary choice by the analyst.

A drawback of CART is that with response rates of 0.01% to 10% which is not an uncommon response rate in a fundraising campaign, particularly a capital or planned giving campaign, Cart will often build no tree and classify the whole file as a non donor. One study suggests using a file with as many donors as non donors will get around this problem. This is not an optimal solution if the number of donors in a campaign is very low like in the case of a capital gift campaign.

The foregoing description has been presented for purposes of illustration and description. It is not intended to be exhaustive or to limit the invention to the precise examples or embodiments disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method of identifying best prospective donors from a pool of prospective donors of a non-profit organization, comprising the steps of:
obtaining client data regarding the pool of prospective donors from the non-profit organization;
obtaining public data from a database, the public data including data specific to prospective donors in the pool and general demographic data;
merging the client data with relevant portions of the public data to create composite data for each prospective donor in the pool;
applying statistical analysis to a plurality of key variables from the composite data;
based on the applied statistical analysis, generating a propensity score for each prospective donor in the pool, each respective propensity score indicative of the relative likelihood that the corresponding prospective donor will donate to the non-profit organization as compared to other prospective donors in the pool;
based on the statistical analysis, generating a capacity score for each prospective donor in the pool, each respective capacity score indicative of the financial ability of the corresponding prospective donor to donate to the non-profit organization; and
providing the propensity and capacity scores for each prospective donor in the pool to the non-profit organization whereby the non profit organization is able to target more effectively its requests for donations from the pool of prospective donors.

2. The method of claim 1 wherein the client data comprises one or more of name, address, age, income, marital status, family status, involvement level with the non-profit organization, and donation history to the non-profit organization of each prospective donor in the pool.

3. The method of claim 2 wherein the donation history of each prospective donor in the pool is indicative of the consistency and level of giving by the respective donor to the non-profit organization.

4. The method of claim 1 wherein the public data specific to each prospective donor includes credit report data and asset data.

5. The method of claim 1 wherein the general demographic data include one or more of census data, median income and median home value based on zip code, and aggregate credit data.

6. The method of claim 1 wherein the step of applying statistical analysis comprises developing a custom statistical model based on probit regression analysis using the key variables relevant to the non-profit organization.

7. The method of claim 6 further comprising testing the custom statistical model on composite data of prospective donors not in the pool using receiver/operator characteristic, r-squared, and d-prime to determine the accuracy and reliability of the custom statistical model.

8. The method of claim 1 wherein the step of applying statistical analysis comprises developing a prescriptive statistical model based on probit regression analysis using both industry data and the key variables relevant to the non-profit organization.

9. The method of claim 8 further comprising testing the prescriptive statistical model on composite data of prospective donors not in the pool using receiver/operator characteristic, r-squared, and d-prime to determine the accuracy and reliability of the prescriptive statistical model.

10. The method of claim 1 wherein the propensity score includes an annual gift likelihood score.

11. The method of claim 1 wherein the propensity score includes a major gift likelihood score.

12. The method of claim 1 wherein the propensity score includes a planned gift likelihood score.

13. The method of claim 1 wherein the capacity score is indicative of a dollar value range in which the prospective donor is likely to donate to the non-profit organization;

14. The method of claim 1 further comprising the step of ranking the prospective donors based on their respective propensity score.

15. The method of claim 1 further comprising the step of ranking the prospective donors based on their respective capacity score.

16. The method of claim 1 further comprising providing specific financial information about each prospective donor in the pool to the non-profit organization, the specific financial information including one or more of property ownership data, salary data, membership data, political contribution data, stock ownership data, and business title data.

17. The method of claim 1 further comprising formatting the client data into a standardized format.

18. The method of claim 1 further comprising identifying only a top plurality of prospective donors from the pool based on their respective propensity and capacity scores, creating a report with a list of the top plurality, associating specific financial information about each prospective donor of the top plurality in the report, and providing the report to the non-profit organization.

19. The method of claim 18 wherein the report is provided to the non-profit organization as part of a software viewer application having a graphic user interface by which the non-profit organization is able to view the report.

20. The method of claim 18 wherein the report is accessible by the non-profit organization over the Internet through a password-protected web interface.

21. A method of identifying best prospective donors from a pool of prospective donors of a non-profit organization, comprising the steps of:
obtaining client data regarding the pool of prospective donors from the non-profit organization, wherein the client data comprises one or more of name, address, age, income, marital status, family status, involvement level with the non-profit organization, and donation history to the non-profit organization of each prospective donor in the pool;
obtaining public data from a database, the public data including data specific to prospective donors in the pool and general demographic data;
merging the client data with relevant portions of the public data to create composite data for each prospective donor in the pool;
generating statistical models having a plurality of key variables based on probit regression analysis of the composite data;
generating a plurality of propensity scores for each prospective donor in the pool by applying the statistical models to the plurality of key variables in the composite data, each of the plurality of propensity scores indicative of the relative likelihood that the corresponding prospective donor will donate an annual gift, a major gift, and a planned gift to the non-profit organization as compared to other prospective donors in the pool;
generating a capacity score for each prospective donor in the pool by applying the statistical models to the plurality of key variables in the composite data, each respective capacity score indicative of the financial ability of the corresponding prospective donor to donate to the non-profit organization; and
providing the propensity and capacity scores for each prospective donor in the pool to the non-profit organization whereby the non profit organization is able to target more effectively its requests for donations from the pool of prospective donors.

21. The method of claim 20 wherein the donation history of each prospective donor in the pool is indicative of the consistency and level of giving by the respective donor to the non-profit organization.

22. The method of claim 20 wherein the public data specific to each prospective donor includes credit report data and asset data.

23. The method of claim 20 wherein the general demographic data include one or more of census data, median income and median home value based on zip code, and aggregate credit data.

24. The method of claim 20 wherein at least one of the statistical models is customized using the key variables relevant to the non-profit organization.

25. The method of claim 24 further comprising testing the customized statistical model on composite data of prospective donors not in the pool using receiver/operator characteristic, r-squared, and d-prime to determine the accuracy and reliability of the customized statistical model.

26. The method of claim 20 wherein at least one of the statistical models is prescriptive using both industry data and the key variables relevant to the non-profit organization.

27. The method of claim 26 further comprising testing the prescriptive statistical model on composite data of prospective donors not in the pool using receiver/operator characteristic, r-squared, and d-prime to determine the accuracy and reliability of the prescriptive statistical model.

28. The method of claim 20 wherein the capacity score is indicative of a dollar value range in which the prospective donor is likely to donate to the non-profit organization.

29. The method of claim 20 further comprising the step of ranking the prospective donors based on one of their respective propensity scores.

30. The method of claim 20 further comprising the step of ranking the prospective donors based on all of their respective propensity scores.

31. The method of claim 20 further comprising the step of ranking the prospective donors based on their respective capacity score.

32. The method of claim 20 further comprising providing specific financial information about each prospective donor in the pool to the non-profit organization, the specific financial information including one or more of property ownership data, salary data, membership data, political contribution data, stock ownership data, and business title data.

33. The method of claim 20 further comprising formatting the client data into a standardized format before merging the client data with relevant portions of the public data.

34. The method of claim 20 further comprising identifying only a top plurality of prospective donors from the pool based on their respective propensity and capacity scores, creating a report with a list of the top plurality, associating specific financial information about each prospective donor of the top plurality in the report, and providing the report to the non-profit organization.

35. The method of claim 34 wherein the report is provided to the non-profit organization as part of a software viewer application having a graphic user interface by which the non-profit organization is able to view the report.

36. The method of claim 34 wherein the report is accessible by the non-profit organization over the Internet through a password-protected web interface.

37. A method of identifying best prospective donors of a particular planned gift from a pool of prospective donors of a specific non-profit organization, comprising the steps of:
developing a statistical model indicative of the likelihood of an individual to make the particular planned gift in contrast with other types of planned gifts, the statistical model based on historical data of a plurality of individuals who have historically made donations of the particular planned gift to non-profit organizations, the statistical model having a plurality of key variables;
obtaining client data regarding the pool of prospective donors from the specific non-profit organization;
generating a propensity score for each prospective donor in the pool by applying the statistical model to the plurality of key variables in the client data, each respective propensity score indicative of the relative likelihood that the corresponding prospective donor will donate the planned gift to the specific non-profit organization as compared to other prospective donors in the pool; and
providing the propensity score for each prospective donor in the pool to the non-profit organization whereby the non profit organization is able to target more effectively its requests for donations using the planned gift from the pool of prospective donors.

38. The method of claim 37 wherein the planned gift is a bequest.

39. The method of claim 37 wherein the planned gift is a charitable remainder trust.

40. The method of claim 37 wherein the planned gift is a charitable gift annuity.

41. The method of claim 37 wherein the planned gift is a pooled income fund.

42. The method of claim 37 wherein the planned gift is life insurance.

43. The method of claim 37 wherein the client data comprises one or more of name, address, age, income, marital status, family status, involvement level with the non-profit organization, and donation history to the non-profit organization of each prospective donor in the pool.

44. The method of claim 43 wherein the donation history of each prospective donor in the pool is indicative of the consistency and level of giving by the respective donor to the non-profit organization.

45. The method of claim 37 further comprising the step of ranking the prospective donors based on their respective propensity score.

46. The method of claim 37 further comprising extracting the plurality of key variables from the client data before generating the propensity scores.

47. The method of claim 37 further comprising identifying only a top plurality of prospective donors from the pool based on their respective propensity scores, creating a report with a list of the top plurality, and providing the report to the specific non-profit organization.

48. The method of claim 47 wherein the report is provided to the specific non-profit organization as part of a software viewer application having a graphic user interface by which the specific non-profit organization is able to view the report.

49. The method of claim 47 wherein the report is accessible by the specific non-profit organization over the Internet through a password-protected web interface.

50. A method of identifying best prospective donors of a plurality of planned gifts from a pool of prospective donors of a specific non-profit organization, comprising the steps of:
developing a plurality of statistical models, each statistical model associated with a respective one of the plurality of planned gifts, each statistical model based on historical data of individuals who have historically made donations of the respective one of the plurality of planned gifts to a non-profit organization, each statistical model having a respective plurality of key variables;
obtaining client data regarding the pool of prospective donors from the specific non-profit organization;
for each respective statistical model, generating a propensity score for each prospective donor in the pool by applying the statistical model to the respective plurality of key variables in the client data, each respective propensity score indicative of the relative likelihood that the corresponding prospective donor will donate the associated planned gift to the specific non-profit organization as compared to other prospective donors in the pool; and
providing the propensity scores for each prospective donor in the pool to the non-profit organization whereby the non profit organization is able to target more effectively its requests for donations using the plurality of planned gift from the pool of prospective donors.

51. The method of claim 50 wherein one of the planned gifts is a bequest.

52. The method of claim 50 wherein one of the planned gifts is a charitable remainder trust.

53. The method of claim 50 wherein one of the planned gifts is a charitable gift annuity.

54. The method of claim 50 wherein one of the planned gifts is a pooled income fund.

55. The method of claim 50 wherein one of the planned gifts is life insurance.

56. The method of claim 50 further comprising the step of ranking the prospective donors based on their respective propensity scores.

57. The method of claim 50 further comprising extracting the plurality of key variables from the client data before generating the propensity scores.

58. The method of claim 50 further comprising identifying only a top plurality of prospective donors from the pool based on their respective propensity scores, creating a report with a list of the top plurality, and providing the report to the specific non-profit organization.

59. The method of claim 58 wherein the report is provided to the specific non-profit organization as part of a software viewer application having a graphic user interface by which the specific non-profit organization is able to view the report.

60. The method of claim 58 wherein the report is accessible by the specific non-profit organization over the Internet through a password-protected web interface.
